(19) United States
(12) Patent Application Publication
(10) Pub. No.: US 2023/0371629 A1
(43) Pub. Date: Nov. 23, 2023

(54) REINFORCEMENT MATERIAL FOR A GARMENT, AND METHOD FOR MANUFACTURING THE SAME

(71) Applicant: STEDFAST INC., Granby, Quebec (CA)

(72) Inventor: Martin FILTEAU, Mont St-Hilaire, Quebec (CA)

(73) Assignee: STEDFAST INC., Granby, Quebec (CA)

(21) Appl. No.: 18/044,498

(22) PCT Filed: Sep. 9, 2021
(86) PCT No.: PCT/CA2021/051243

§ 371 Date: Mar. 8, 2023

Related U.S. Application Data
(60) Provisional application No. 63/075,885, filed on Sep. 9, 2020.

(51) Int. Cl. A41D 31/24; A41D 31/08

(52) U.S. Cl. CPC A41D 31/245; A41D 31/08; A41D 2500/54

(57) ABSTRACT

There is provided a reinforcement material for a garment, the garment having at least one region exposed to external mechanical forces. The reinforcement material includes a piece of fabric, the piece of fabric including a plurality of micrometric pores distributed among a surface of the piece of fabric. The micrometric pores are sized, positioned and oriented to allow a passage of at least one of: heat, moisture, vapors and water therethrough. The piece of fabric has abrasion resistance properties and breathability properties and is configured to be affixed to the garment in the region(s) exposed to the external mechanical forces, thereby enhancing the mechanical resistance of the garment without significantly affecting breathability properties of the garment, when the piece of fabric is affixed to the garment.

### TECHNICAL FIELD

The technical field generally relates to textile and fabric technology, and more particularly relates to a reinforcement fabric for use in an item of clothing, such as a protective garment, as well as a method for manufacturing the same.

### BACKGROUND

The activities of first responders involve different situations in which their turnout gears or garments may be exposed to external mechanical forces. As a result, the turnout gears or garments may become damaged overtime.

An existing solution to this problem is using reinforcement fabrics to improve the mechanical properties of the turnout gears or garments. These reinforcement fabrics may be, for example, positioned in portions of the turnout gears or garments that are often exposed to external mechanical forces.

While the existing reinforcement fabrics provides the turnout gears or garments with improved mechanical properties, other properties of the turnout gears or garments may be affected in a negative way. More particularly, the use of reinforcement fabrics of the prior art is associated with drawbacks, such as, for example, moisture and heat accumulation in the turnout gears or garments, which may cause harm or injuries to the people wearing the garments. These drawbacks are dangerous for the wearer's health and also decrease the comfort of the wearer.

There remains a need in the art for reinforcement textiles and fabrics that improve the comfort and security of the wearer.

### SUMMARY

A microporous reinforcement fabric for a garment is described herein. In some embodiments, the garment may be a protective garment. In other embodiments, the garment is an item of clothing. The microporous reinforcement fabric has abrasion resistance properties enhancing the mechanical resistance of the garment without significantly affecting the breathability of the garment when the piece of fabric is affixed to the garment, such that the garment can provide adequate protection to a user wearing the garment including the microporous reinforcement fabric, without negatively impacting the comfort of the user.

In accordance with an aspect, there is provided a reinforcement material for a garment, the garment having at least one region exposed to external mechanical forces, the reinforcement material including:
a piece of fabric, the piece of fabric including a plurality of micrometric pores distributed among a surface of the piece of fabric, the micrometric pores being sized, positioned and oriented to allow a passage of at least one of: heat, moisture, vapors and water therethrough,
   wherein the piece of fabric is configured to be affixed to the garment in said at least one region exposed to the external mechanical forces, the piece of fabric having abrasion resistance properties and breathability properties enhancing the mechanical resistance of the garment without significantly affecting breathability properties of the garment when the piece of fabric is affixed to the garment.

In some embodiments, the piece of fabric is made of a layer of aramid fibers coated with a synthetic rubber.

In some embodiments, the synthetic rubber is a fire-resistant rubber.

In some embodiments, the fire-resistant rubber includes chlorosulfonated polyethylene.

In some embodiments, the aramid fibers include poly-paraphenylene terephthalamide.

In some embodiments, the micrometric pores each have a diameter included in a range extending from about 100 μm to about 300 μm.

In some embodiments, the micrometric pores are uniformly distributed among the surface of the piece of fabric.

In some embodiments, the micrometric pores are separated one from another by a constant distance.

In some embodiments, the constant distance is about 3.125 mm.

The reinforcement material of claim 7, wherein the constant distance is about 0.125 inch.

In some embodiments, the micrometric pores are distributed according to a non-uniform pattern.

In some embodiments, the micrometric pores are laser-formed pores.

In some embodiments, the laser-formed are obtained by piercing or perforating a non-perforated piece of fabric with a laser.

In some embodiments, the piece of fabric has washing resistance properties.

In some embodiments, the washing resistance properties include a lack of delamination of the piece of fabric after at least five cycles of washing at a temperature of about 60° C.

In some embodiments, the piece of fabric has a weight ranging between 16 ounces per square yard (opsy) and 20 opsy, or between about 540 g/m² (gsm) and about 680 gsm.

In some embodiments, the piece of fabric has an air permeability of about 10 ft³/min/ft².

In some embodiments, the piece of fabric has a total heat loss (THL) ranging between about 250 W/m² and 300 W/m².

In some embodiments, the THL is about 275 W/m².

In some embodiments, the piece of fabric has a breaking strength of at least about 250 lbs along the warp direction, and at least about 200 lbs along the fill direction.

In some embodiments, the piece of fabric has a tearing strength of at least about 15 lbs along the warp direction, and at least about 15 lbs along the fill direction.

In some embodiments, the piece of fabric is resistant to shrinkage.

In some embodiments, the abrasion resistance properties include an abrasion resistance of at least 3000 cycles.

In some embodiments, at least some of the micrometric pores pass through an entire thickness of the piece of fabric.

In accordance with another aspect, there is provided a protective garment, the protective garment including:
an outer shell having at least one region exposed to external mechanical forces; and
a piece of fabric affixed to the garment in said at least one region exposed to the external mechanical forces, the piece of fabric including a plurality of micrometric pores distributed among a surface of the piece of fabric, the micrometric pores being sized, positioned and oriented to allow a passage of at least one of: heat, moisture, vapors and water therethrough, the piece of fabric having abrasion resistance properties and breathability properties enhancing the mechanical resistance of the protective garment without significantly affecting breathability properties of the protective garment.

In some embodiments, the piece of fabric is made of a layer of aramid fibers coated with a synthetic rubber.

In some embodiments, the synthetic rubber is a fire-resistant rubber.

In some embodiments, the fire-resistant rubber is chlorosulfonated polyethylene.

In some embodiments, the aramid fibers include poly-paraphenylene terephthalamide.

In some embodiments, the micrometric pores each have a diameter included in a range extending from about 100 μm to about 300 μm.

In some embodiments, the micrometric pores are uniformly distributed among the surface of the piece of fabric.

In some embodiments, the micrometric pores are separated one from another by a constant distance.

In some embodiments, the constant distance is about 3.125 mm.

In some embodiments, the constant distance is about 0.125 inch.

In some embodiments, the micrometric pores are distributed according to a non-uniform pattern.

In some embodiments, the micrometric pores are laser-formed pores.

In some embodiments, the laser-formed are obtained by piercing or perforating a non-perforated piece of fabric with a laser.

In some embodiments, the piece of fabric has washing resistance properties.

In some embodiments, the washing resistance properties include a lack of delamination of the piece of fabric after at least five cycles of washing at a temperature of about 60° C.

In some embodiments, the piece of fabric has a weight ranging between 16 ounces per square yard (opsy) and 20 opsy, or between about 540 g/m² (gsm) and about 680 gsm.

In some embodiments, the piece of fabric has an air permeability of about 10 ft³/min/ft².

In some embodiments, the piece of fabric has a total heat loss (THL) ranging between about 250 W/m² and 300 W/m².

In some embodiments, the THL is about 275 W/m².

In some embodiments, the piece of fabric has a breaking strength of at least about 250 lbs along the warp direction, and at least about 200 lbs along the fill direction.

In some embodiments, the piece of fabric has a tearing strength of at least about 15 lbs along the warp direction, and at least about 15 lbs along the fill direction.

In some embodiments, the piece of fabric is resistant to shrinkage.

In some embodiments, the abrasion resistance properties include an abrasion resistance of at least 3000 cycles.

In some embodiments, said at least one region exposed to external mechanical forces is aligned with at least a portion of at least one of: a wrist, an elbow, a knee, a back, a waist, a chest, a shoulder, an arm and a leg of a user when the protective garment is worn by the user.

In some embodiments, at least some of the micrometric pores pass through an entire thickness of the piece of fabric.

In accordance with another aspect, there is provided a method for manufacturing a reinforcement material for a garment, the method including:
providing a non-perforated piece of fabric; and
forming pores in the non-perforated piece of fabric with a laser to obtain a piece of fabric including a plurality of micrometric pores distributed among a surface of the piece of fabric, the micrometric pores being sized, positioned and oriented to allow a passage of at least one of: heat, moisture, vapors and water therethrough.

In some embodiments, the micrometric pores each have a diameter included in a range extending from about 100 μm to about 300 μm.

In some embodiments, said forming the pores includes forming pores uniformly distributed among the surface of the piece of fabric.

In some embodiments, said forming the pores includes forming pores according to a non-uniform pattern.

In accordance with another aspect, there is provided a microporous reinforcement fabric for use in a protective garment. The microporous reinforcement fabric consists of a piece of fabric including a plurality of micrometric pores distributed among a surface of the piece of fabric. The micrometric pores are sized, positioned, and configured to allow transport of heat, moisture, vapors and/or water therethrough. When used in a protective garment, the microporous reinforcement fabric may provide the protective garment with enhanced mechanical resistance without significantly affecting the breathability of the protective garment.

In some embodiments, the piece of fabric is made of a layer of aramid fibers coated with fire-resistant chlorosulfonated polyethylene synthetic rubber (also referred to as “Hypalon™”). The aramid fibers may be poly-paraphenylene terephthalamide (also referred to as “Kevlar™”, “Twaron™”, and “Heracron™”).

In some embodiments, the micrometric pores have a diameter includes in a range extending from about 100 μm to about 300 μm.

In some embodiments, the micrometric pores may be separated one from another by a distance of approximately 3.125 mm (0.125 inch).

In some embodiments, the micrometric pores are evenly distributed among the surface of the piece of fabric.

In some embodiments, the micrometric pores are obtained by piercing or perforating a non-perforated piece of fabric with a laser. The micrometric pores may be perforated according to a pattern.

In some embodiments, the microporous reinforcement fabric may be cleaned and reused several times without substantially affecting the particulate-impermeable properties, air-permeable properties, liquid-permeable properties and/or antimicrobial properties.

In accordance with another aspect, there is provided a protective garment comprising an outer shell and a microporous reinforcement fabric affixed to the outer shell. The microporous reinforcement fabric is positioned in areas of the protective garment exposed to external mechanical forces. The microporous reinforcement fabric consists of a piece of fabric including a plurality of micrometric pores distributed among a surface of the piece of fabric. The micrometric pores are sized, positioned, and configured to allow transport of heat, moisture, vapors and/or water therethrough from a wearer's body through the micrometric pores and away from the protective garment when the protective garment is worn by the wearer. The microporous reinforcement fabric may provide the protective garment with enhanced mechanical resistance without significantly affecting the breathability of the protective garment.

In some embodiments, the piece of fabric is made of a layer of aramid fibers coated with fire-resistant chlorosulfonated polyethylene synthetic rubber (also referred to as “Hypalon™”). The aramid fibers may be Kevlar™.

In some embodiments, the micrometric pores have a diameter includes in a range extending from about 100 μm to about 300 μm.

In some embodiments, the micrometric pores may be separated one from another by a distance of approximately 3.125 mm (0.125 inch).

In some embodiments, the micrometric pores are evenly distributed among the surface of the piece of fabric.

In some embodiments, the micrometric pores are obtained by piercing or perforating a non-perforated piece of fabric with a laser. The micrometric pores may be perforated according to a pattern.

In some embodiments, the microporous reinforcement fabric may be cleaned and reused several times without substantially affecting the particulate-impermeable properties, air-permeable properties, liquid-permeable properties and/or antimicrobial properties.

In some embodiments, the areas of the protective garment exposed to external mechanical forces includes cuffs, elbows and/or knees.

Other features and advantages of the present invention will be better understood upon a reading of embodiments thereof with reference to the appended drawings.

### BRIEF DESCRIPTION OF THE DRAWINGS

FIG. 1 is a schematic representation of a reinforcement material, in accordance with one embodiment.

FIG. 2 is a picture of a reinforcement material.

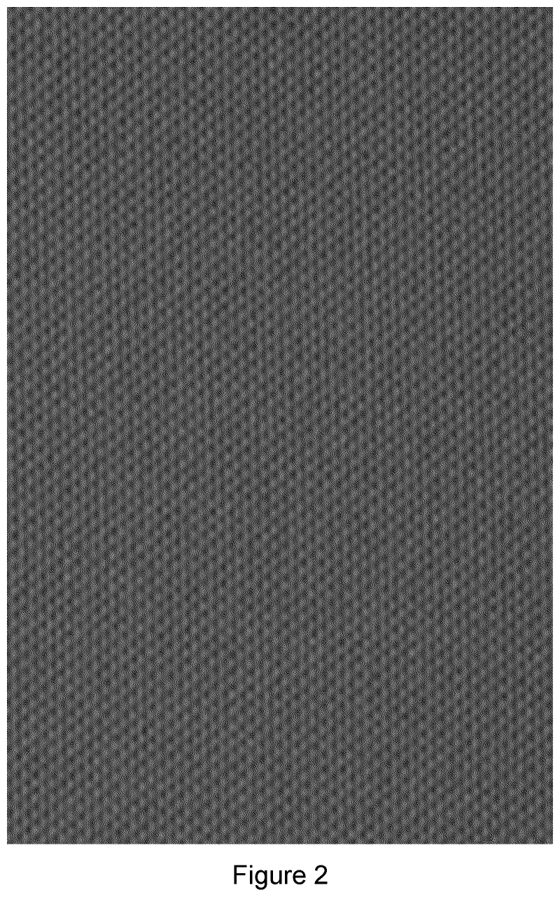

FIGS. 3A and 3B each presents a schematic representation illustrating a cross-section of a reinforcement membrane, in accordance with one embodiment.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

It will be appreciated that positional descriptors indicating the position or orientation of one element with respect to another element are used herein for ease and clarity of description and should, unless otherwise indicated, be taken in the context of the figures and should not be considered limiting. It will be understood that spatially relative terms (e.g., “outward” and “inward”, “frontward” and “rearward”, “front” and “rear”, “left” and “right”, “top” and “bottom” and “outer” and “inner”) are intended to encompass different positions and orientations in use or operation of the present embodiments, in addition to the positions and orientations exemplified in the figures.

The present description generally refers to textile or fabric technology, and more particularly to a reinforcement material for use in protective garments. The reinforcement material may have particulate-impermeable properties (sometimes referred to as “particulate barrier” or “particulate-barrier properties”), air-permeable properties, liquid-permeable properties and/or antimicrobial properties. For example, the reinforcement material may be used in firefighter garments or protective garments worn by other first responders.

The expression “protective garment” refers to the personal protective equipment used by firefighters or other first responders. The term can refer to the trousers (pants), boots and jacket (coat), or any combination combinations thereof. Other expressions such as “bunker gear” or “turnout gear” may also be used. The expression “garment” generally refers to an item of clothing.

The term “fabric” refers specifically to a woven or knitted material, and more generally to flexible materials comprising a network of natural fibers, artificial fibers or combination thereof. Unless otherwise specified, the description of the fabric is applicable to both woven and knitted materials, as well as to other materials that will be later introduced and described.

The expressions “warp” and “fill” refer to an orientation of the woven fabric. The warp direction generally includes threads that extend along the length of the fabric, which may also be described as the “machine direction”. The fill direction generally includes yarns that are pulled and inserted perpendicularly to the warp yarns across the width of the fabric.

The term “textile” as used herein is meant to generally refer to an element manufactured from natural or synthetic (i.e., man-made) fibers or filaments or monofilaments. Non-limiting examples of synthetic fibers or filaments include polyester, polyamide (e.g., Nylon) aramid or meta-aramid (e.g., Kevlar™, Technora™, Twaron™, Nomex™, Teijinvonex™, Kermel™ and Hecracron™) Zylon™, polyethylene (PE), polytetrafluoroethylene (ePTFE), polyphenylene sulfide (PPS), polyetheretherketone (PEEK), acrylic, modacrylic, polyurethane (e.g., spandex or Lycra™), olefin fibers, polylactide fibers (ingeo), metallic fibers (e.g., lurex) and milk or casein protein fibers. Non-limiting examples of natural fibers or filaments include wool, silk, cashmere, hemp, flax (linen), cotton and bamboo fibers. Non-limiting examples of such elements include yarns, threads and fabrics.

The expressions “flame-resistant”, “flame-retardant”, “fire-resistant” and “fire-retardant” will be understood as the property of a material (e.g., solid, liquid or gas) or design (e.g., a structure) to resist the effects of any fire to which the material or structure can be expected to be subjected, but will also encompass the term “flame-retardant”, namely the property of a material (e.g., solid, liquid or gas) to inhibit combustion.

In the current disclosure, the expression “mechanical properties” or the like may include, but are not limited, to fiber strength, elongation, elasticity, abrasion resistance and modulus of elasticity. Measurements of such mechanical properties may be achieved using techniques known in the art.

Embodiments of a reinforcement material and its integration into protective garments will now be described.

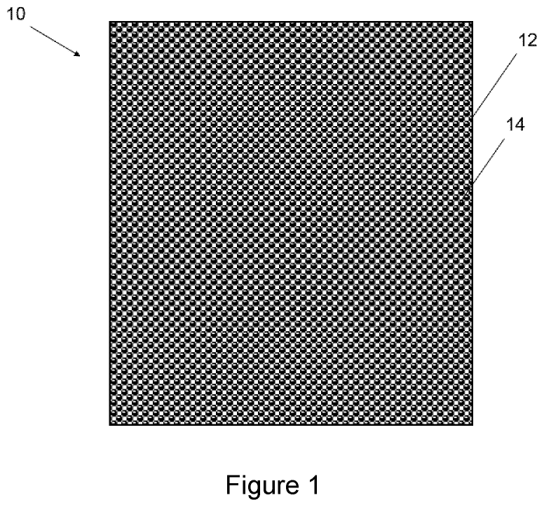

Referring to FIG. 1, an embodiment of a reinforcement material 10 is illustrated.

The reinforcement material 10, which will sometimes be referred to as a “microporous reinforcement fabric” includes and preferably consists of a piece of fabric 12 having a plurality of micrometric pores 14 distributed among a surface of the piece of fabric 12. The micrometric pores 14 are configured, i.e., sized, positioned, and oriented to allow a passage, transport or circulation of heat, moisture, vapors and/or water therethrough. When the piece of fabric 12 is applied to a garment or a protective garment, heat, moisture, vapors and/or water may be transported from the wearer's body through the micrometric pores 14 and away from the garment or protective garment. The reinforcement material 10, and more specifically the piece of fabric 10, can be permanently or removably attached or affixed to the garment. In some embodiments, the reinforcement material 10 is affixed using seams or similar mechanisms. The piece of fabric 12 has abrasion resistance properties and breathability properties that are such that the piece of fabric 12 may enhance the mechanical resistance of the garment without significantly affecting breathability properties of the garment. It will be noted that the expressions “micrometric pores”, “micrometric perforations” and any derivatives thereof may be used interchangeably.

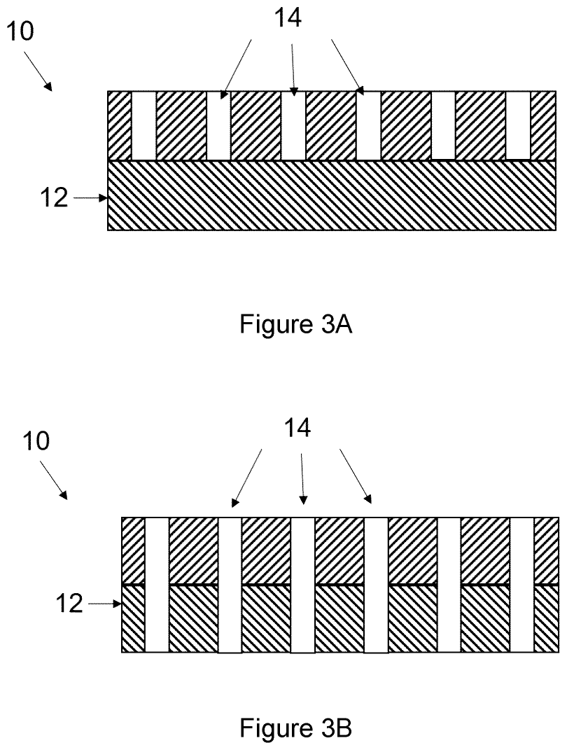

In some embodiments, the piece of fabric 12 is made of a layer of aramid fibers (acting as a “substrate layer”) coated with fire-resistant chlorosulfonated polyethylene synthetic rubber (also referred to as “Hypalon™”). The aramid fibers may be Kevlar™. Of course, the piece of fabric 12 could include one or more layers and other similar may be used. The micrometric pores 14 may be provided in the fire-resistant chlorosulfonated polyethylene synthetic rubber only, and there are no micrometric pores or perforations in the layer of aramid fibers. In this embodiment, the micrometric pores 14 do not pass through the layer of aramid fibers, as illustrated in FIG. 3A. Alternatively, at least some micrometric pores or perforations may be provided in the aramid fibers, as illustrated in FIG. 3B.

The reinforcement material 10 has mechanical properties, particulate-impermeable properties, air-permeable properties, liquid-permeable properties and/or antimicrobial properties. The mechanical properties may include, for example and without being limitative, flexibility and mechanical resistance to abrasion and puncture. The air-permeability properties may allow the passage of air while blocking carcinogenic particulate matter and other particulates potentially hazardous to the health of the wearer, which may be sized for example between about 0.1 μm and about 1 μm. The combination of the mechanical properties, particulate-impermeable properties, air-permeable properties, liquid-permeable properties and antimicrobial properties optimise both the comfort and the security of the wearer. In some embodiments, the reinforcement material 10 may meet specific requirements with respect to air permeability. Preferably, the reinforcement material 10 has an overall air permeability which is high enough so that sufficient air can circulate through micrometric pores 14 provided in the reinforcement material 10. This feature may be useful to provide a degree of breathability and/or cooling to the wearer, while being low enough to maintain adequate mechanical properties. In addition, this feature may reduce the likelihood of suffering from steam burns when wearing the protective garment.

In some embodiments, the micrometric pores 14 have a diameter includes in a range extending from about 100 μm to about 300 μm. In a nonlimitative example, the micrometric pores 14 may be separated one from another by a distance of approximately 3.125 mm (0.125 inch). Of course, the density of the micrometric pores 14 may be adjusted according to a targeted application, and so the distance between could be smaller than 3.125 mm. Alternatively, the distance could be greater than 3.125 mm.

In some embodiments, the micrometric pores 14 are obtained by piercing a non-perforated piece of fabric with a laser. Perforating the micrometric pores 14 using a laser may allow obtaining micrometric pores 14 having a relatively precise and controlled diameter. The perforation may be made according to a pattern. For example, the micrometric pores 14 may be evenly distributed among the surface of the piece of fabric 12. Alternatively, the micrometric pores 14 may be randomly distributed.

In some embodiments, the reinforcement material 10 may be cleaned and reused several times without substantially affecting the mechanical properties, particulate-impermeable properties, air-permeable properties, liquid-permeable properties and/or antimicrobial properties.

Of note, the embodiments of the reinforcement material 10 herein described meet and, in some instances, may exceed the requirements of NFPA 1971:2018, ASNZ 4967:2009, EN469 and/or EN15614. The reinforcement material 10 has thermal protection properties and abrasion resistance properties allowing the integration of the reinforcement material 10 into protective garments. The reinforcement material 10 is also flexible, flame, water and chemical resistant, tear resistant and resistant to relatively low temperature.

In some embodiments, the piece of fabric has washing resistance properties.

In some embodiments, the washing resistance properties include a lack of delamination of the piece of fabric after at least five cycles of washing at a temperature of about 60° C.

In some embodiments, the piece of fabric has a weight ranging between 16 ounces per square yard (opsy) and 20 opsy, or between about 540 g/m² (gsm) and about 680 gsm.

In some embodiments, the piece of fabric has an air permeability of about 10 ft³/min/ft².

In some embodiments, the piece of fabric has a total heat loss (THL) ranging between about 250 W/m² and 300 W/m².

In some embodiments, the THL is about 275 W/m².

In some embodiments, the piece of fabric has a breaking strength of at least about 250 lbs along the warp direction, and at least about 200 lbs along the fill direction.

In some embodiments, the piece of fabric has a tearing strength of at least about 15 lbs along the warp direction, and at least about 15 lbs along the fill direction.

In some embodiments, the piece of fabric is resistant to shrinkage.

In some embodiments, the abrasion resistance properties include an abrasion resistance of at least 3000 cycles.

In some embodiments, at least some of the micrometric pores pass through an entire thickness of the piece of fabric.

Now that the characteristics of the reinforcement material 10 have been described, an example of an implementation of the microporous reinforcement fabric in a protective garment will be presented.

The protective garment may include an outer shell and a microporous reinforcement fabric affixed to the outer shell. The microporous reinforcement fabric is similar to the one having been previously described.

The microporous reinforcement fabric may be positioned in areas of the protective garment exposed to external mechanical forces and that may be potentially wear over time without the presence of a reinforcement fabric. As such, the protective garment may be equipped with a plurality of microporous reinforcement fabrics, each being aligned with a corresponding area of the protective garment exposed to external mechanical forces. Nonlimitative examples of such areas are cuffs, elbows and/or knees. It will be noted that the microporous reinforcement membrane 10 may be positioned in locations of the outer shell corresponding to areas of the body of high rates of perspiration and metabolic heat transfer. Nonlimitative examples of such areas of high rates of perspiration and metabolic heat transfer are the cuffs, elbows, knees, back, a side torso, or an ankle of the wearer. In some embodiments, the microporous reinforcement fabric may provide the protective garment with enhanced mechanical resistance without significantly affecting the breathability of the protective garment.

In some embodiments, the protective garment and the microporous reinforcement fabric(s) provided thereon may be cleaned and reused several times without substantially affecting the particulate-impermeable properties, air-permeable properties, liquid-permeable properties and/or antimicrobial properties of the protective garment and the microporous reinforcement garment.

In some aspects, there is also provided a method for manufacturing a reinforcement material for a garment. The method includes providing a non-perforated piece of fabric and forming pores in the non-perforated piece of fabric with a laser to obtain a piece of fabric including a plurality of micrometric pores distributed among a surface of the piece of fabric. The micrometric pores are similar to the ones having been previously described. In some embodiments, the micrometric pores each have a diameter included in a range extending from about 100 μm to about 300 μm. In some embodiments, the step of forming the pores includes forming pores uniformly distributed among the surface of the piece of fabric. In some embodiments, the step of forming the pores includes forming pores according to a non-uniform pattern.

Examples of Results

The section below provides examples of embodiments of results related to embodiments of the microporous reinforcement fabric. The following section should not be interpreted as being limitative and serves an illustrative purpose only.

Table 1 presents a comparison between three samples, namely sample A (prior art), sample B (prior art) and sample C (the microporous reinforcement fabric herein described). Sample A is made from DragonHide™ and sample B is the regular Stedshield™ FR. Sample C is made of a layer of aramid fibers coated with fire-resistant chlorosulfonated polyethylene synthetic rubber and comprising micrometric pores having a diameter included in the range extending from 100 μm to about 300 μm.

TABLE 1
Example of results for Samples A, B and C

| | | | | | | | Sample C |
|---|---|---|---|---|---|---|---|
| | | | | | | | (microporous |
| | | | | Sample A | | Sample B | reinforcement |
| Property | Method | Specifications | | (PRIOR ART) | | (PRIOR ART) | fabric) |
| Mass (opsy) | ASTM D 3776 | 9.5-10.5 | | 9.7 | | 20.4 | 19.6 |
| Thickness (mil.) | ONGC 37 | 19-25 | | 21.0 | | 26 | 25.5 |
| Width (inches) | ONGC 4.1 | 58-61 | | 60.75 (usable) | | 63 ¾ | — |
| Washings | Visual | No | | No | | No | No |
| Resistance | | delamination | | delamination | | delamination | delamination |
| After 5 cycles | | | | | | | |
| @ 60° C. | | | | | | | |
| Breaking | ASTM | Warp | 250 lbf Min. | Warp (lbf) | 305 | 311 | 294 |
| Strength | D 5034 | Filler | 200 lbf Min. | Filler (lbf) | 248 | 248 | 130 |
| initial | | | | | | | |
| (lbf) | | | | | | | |
| Tear Strength | ASTM | 15 lbf Min. | | Warp (lbf) | 20.3 | 32.7 | 30.8 |
| Initial | D 5587 | 13 lbf Min. | | Filler (lbf) | 18.1 | 26.3 | 34.1 |
| Flame | ASTM | No melting or | | Warp | | Warp | Warp |
| Resistance | D 6413 | dripping | | After | 0 | 0 | 0 |
| Initial | | Maximum | | flame | | | |
| (sec.) | | After flame: 2 | | time | | | |
| | | seconds | | (sec.) | | | |
| | | Char length: 4 | | After | 1.88 | 0 | 0.46 |
| | | inches | | glow | | | |
| | | | | (sec.) | | | |
| | | | | Char | 0.25 | 0 | 0 |
| | | | | length | | | |
| | | | | (inches) | | | |
| | | | | Filler | | Filler | Filler |
| | | | | After | 0 | 0 | 0 |
| | | | | flame | | | |
| | | | | time | | | |
| | | | | (sec.) | | | |
| | | | | After | 1.95 | 1.20 | 0.94 |
| | | | | glow | | | |
| | | | | (sec.) | | | |
| | | | | Char | 0.50 | 0 | 0 |
| | | | | length | | | |
| | | | | (inches) | | | |
| Flame | ASTM | No melting or | | Warp | | Warp | Warp |
| Resistance | D 6413 | dripping | | After | 0 | 0 | 0 |
| After 5 | | Maximum | | flame | | | |
| cycles @ | | After flame: 2 | | time | | | |
| 60° C. | | seconds | | (sec.) | | | |
| (sec.) | | Char length: 4 | | After | 2.63 | 0.19 | 0 |
| | | inches | | glow | | | |
| | | | | (sec.) | | | |
| | | | | Char | 0.50 | 0 | 0 |
| | | | | length | | | |
| | | | | (inches) | | | |
| | | | | Filler | | Filler | Filler |
| | | | | After | 0 | 0 | 0 |
| | | | | flame | | | |
| | | | | time | | | |
| | | | | (sec.) | | | |
| | | | | After | 2.12 | 0.34 | 0.93 |
| | | | | glow | | | |
| | | | | (sec.) | | | |
| | | | | Char | 0.5 | 0 | 0 |
| | | | | length | | | |
| | | | | (inches) | | | |
| Heat and | NFPA 1971 | Maximum 10% | | Warp | −0.42 | −0.42 | −.021 |
| Thermal | 8.6 (p. 49) | | | Filler | 0 | 0 | 0 |
| Shrinkage | AATCC 135 | | | | | | |
| Resistance Test | | | | | | | |
| (Initial) (%) | | | | | | | |
| Heat and | NFPA 1971 | Maximum 10% | | Warp | −0.42 | −0.32 | −0.21 |
| Thermal | 8.6 (p. 49) | | | Filler | 0.13 | 0 | 0 |
| Shrinkage | And | | | | | | |
| Resistance | AATCC 135 | | | | | | |
| Test | | | | | | | |
| After 5 cycles | | | | | | | |
| @ 60° C. (%) | | | | | | | |
| Requirement for | ASTM | Number of | | No perforation | | Abrasion on | (15.4% lost) |
| Sample A | D 3884 | cycles until | | until 3500 | | coating side | |
| Abrasion on | H-18 | perforation | | cycles (3.1% | | Coating lost at | |
| fabric side | Weight | | | lost) | | 2500 cycles | |
| (checked after | 2 × 1000 g | | | | | Perforation at | |
| 3500 cycles) | | | | | | 3500 cycles | |
| | | | | | | (18% lost) | |
| Requirement for | ASTM | % lost after | | — | | 4.0% lost | 3.3% lost |
| Sample B | D 3884 | 600 cycles | | | | | |
| Abrasion on | H-18 | Maximum 5.5% | | | | | |
| coating side | Weight | | | | | | |
| | 2 × 1000 g | | | | | | |

Table 2 presents other properties of the microporous reinforcement fabric. The results presented in Table 2 were obtained with a test for evaluating thermal and evaporative resistance of clothing materials using a sweating hot plate. More particularly, this test allows determining the total heat loss (THL) of a sample in a standard environment. One layer (thickness: 0.8 mm) of the microporous reinforcement fabric was characterized with an airflow velocity of 1.0±0.1 m/s. The wrinkle removal method used for this test was smoothing without compressing.

TABLE 2
Example of results for the microporous reinforcement fabric

| Results | Data |
|---|---|
| Thermal Resistance (L · m²/W) | 0.0051 |
| Evaporative Resistance (PA · m²/W) | 45.1444 |
| Evaporative Resistance (kPa · m²/W) | 0.0451 |
| Total Heat Loss (W/m²) | 295.25 |

Table 3 presents permeability properties of the microporous reinforcement fabric. The results presented in Table 3 under conditioning atmosphere (21° C. and 65% R.H.). The tests were done using a Frazier Low Pressure Air Permeability Machine.

TABLE 3
Example of results for the microporous reinforcement fabric

| | | | | | | | Standard | |
|---|---|---|---|---|---|---|---|---|
| Results | Individual Data | | | | | Average | Deviation | % CV |
| Permeability | 9.3 | 10.6 | 9.3 | 9.1 | 9.9 | 9.4 | 0.7 | 7.4 |
| (cm³/ | 9.3 | 8.6 | 8.2 | 10.1 | 9.3 | | | |
| cm² · s − 1) | | | | | | | | |
| Permeability | 18.3 | 20.9 | 18.3 | 17.9 | 19.5 | 18.4 | 1.4 | 7.4 |
| (ft³/ | 18.3 | 16.9 | 16.2 | 19.8 | 18.3 | | | |
| ft² · min − 1) | | | | | | | | |

As it has been previously mentioned, the different embodiments of the microporous reinforcement fabric described in the current description may be compliant with the National Fire Protection Association Standard on Protective Ensembles for Structural Fire Fighting and Proximity Fire Fighting. More particularly, the microporous reinforcement fabric herein described generally comply with NFPA 1971. Table 4 presents a comparison between the NFPA 1971-2018 minimal requirements and some of the properties of the microporous reinforcement fabric.

TABLE 4
Example of results for the microporous reinforcement fabric

| | NFPA 1971-2018 | |
|---|---|---|
| Property | Requirements | Microporous reinforcement fabric |
| Weight | — | 18.9 opsy |
| ASTM D-3776 | | |
| Breaking Strength | W: 250 lbs minimum | W: 360 lbs |
| ASTM D-5034 | F: 200 lbs minimum | F: 280 lbs |
| Tearing Strength | W: 15 lbs minimum | W: 25 lbs |
| ASTM D-5587 | F: 15 lbs minimum | F: 25 lbs |
| Flame Resistance | After flame: 2 sec | After flame |
| ASTM 6413 | maximum | Initial |
| | Char length: 4 inches | W: 0.5 sec |
| | maximum no drip, no melt | F: 0.3 sec |
| | | 5 W |
| | | W: 0.6 sec |
| | | F: 0.03 sec |
| | | Char length |
| | | Initial |
| | | W: 0.17 in. |
| | | F: 0.16 in. |
| | | 5 W |
| | | W: 0.12 sec |
| | | F: 0.09 sec |
| Resistance to Abrasion | — | 3000 cycles minimum |
| ASTM D-3884 | | |
| Thermal shrinkage | 10% maximum | Initial |
| NFPA 1971-2018 | | W: 0.09% |
| | | F: 0.06% |
| | | 5 W |
| | | W: 0.03% |
| | | F: 0.09% |
| | EN469/EN15614 | |
| | Requirements | Microporous reinforcement fabric |
| Weight | — | 640 g/m² |
| Flame Spread | No afterglow | No afterglow |
| EN ISO 15025:2003-02 | No occurrence of debris | No occurrence of debris |
| Procedure A | No formation of hole | No formation of hole |
| | Mean after flame <2 sec. | Mean after flame = 0 sec. |
| Heat Resistance | Materials shall not ignite or | No melt, drip, separation or ignition |
| EN ISO 17493:2000 | melt | Shrinkage |
| 180° C. for 5 mins | Shrinkage <5% | L = 0.1% |
| After 5 wash-dry cycles | | W = 0.2% |

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the scope defined in the current description and in the claims.

1. A reinforcement material for a garment, the garment having at least one region exposed to external mechanical forces, the reinforcement material comprising:
a piece of fabric, the piece of fabric comprising a plurality of micrometric pores distributed among a surface of the piece of fabric, the micrometric pores being sized, positioned and oriented to allow a passage of at least one of: heat, moisture, vapors and water therethrough,
wherein the piece of fabric is configured to be affixed to the garment in said at least one region exposed to the external mechanical forces, the piece of fabric having abrasion resistance properties and breathability properties enhancing the mechanical resistance of the garment without significantly affecting breathability properties of the garment when the piece of fabric is affixed to the garment.

2. The reinforcement material of claim 1, wherein the piece of fabric is made of a layer of aramid fibers coated with a synthetic rubber.

3. The reinforcement material of claim 2, wherein the synthetic rubber is a fire-resistant rubber.

4. The reinforcement material of claim 3, wherein the fire-resistant rubber comprises chlorosulfonated polyethylene.

5. The reinforcement material of claim 2, wherein the aramid fibers comprise poly-paraphenylene terephthalamide.

6. The reinforcement material of claim 1, wherein the micrometric pores each have a diameter included in a range extending from about 100 μm to about 300 μm.

7. The reinforcement material of claim 1, wherein the micrometric pores are uniformly distributed among the surface of the piece of fabric.

8. The reinforcement material of claim 7, wherein the micrometric pores are separated one from another by a constant distance.

9. The reinforcement material of claim 8, wherein the constant distance is about 3.125 mm or about 0.125 inch.

10. (canceled)

11. The reinforcement material of claim 1, wherein the micrometric pores are distributed according to a non-uniform pattern.

12. The reinforcement material of claim 1, wherein the micrometric pores are laser-formed pores.

13. (canceled)

14. The reinforcement material of claim 1, wherein the piece of fabric has washing resistance properties, the washing resistance properties comprising a lack of delamination of the piece of fabric after at least five cycles of washing at a temperature of about 60° C.

15. (canceled)

16. The reinforcement material of claim 1, wherein the piece of fabric has a weight ranging between 16 ounces per square yard (opsy) and 20 opsy, or between about 540 g/m² (gsm) and about 680 gsm.

17. The reinforcement material of claim 1, wherein the piece of fabric has an air permeability of about 10 ft³/min/ft².

18. The reinforcement material of claim 1, wherein the piece of fabric has a total heat loss (THL) ranging between about 250 W/m² and 300 W/m².

19. (canceled)

20. The reinforcement material of claim 1, wherein the piece of fabric has a breaking strength of at least about 250 lbs along the warp direction, and at least about 200 lbs along the fill direction.

21. The reinforcement material of claim 1, wherein the piece of fabric has a tearing strength of at least about 15 lbs along the warp direction, and at least about 15 lbs along the fill direction.

22. (canceled)

23. (canceled)

24. The reinforcement material of claim 1, wherein at least some of the micrometric pores pass through an entire thickness of the piece of fabric.

25. A protective garment, the protective garment comprising:
an outer shell having at least one region exposed to external mechanical forces; and
a piece of fabric affixed to the garment in said at least one region exposed to the external mechanical forces, the piece of fabric comprising a plurality of micrometric pores distributed among a surface of the piece of fabric, the micrometric pores being sized, positioned and oriented to allow a passage of at least one of: heat, moisture, vapors and water therethrough, the piece of fabric having abrasion resistance properties and breathability properties enhancing the mechanical resistance of the protective garment without significantly affecting breathability properties of the protective garment.

26-49. (canceled)

50. A method for manufacturing a reinforcement material for a garment, the method comprising:
providing a non-perforated piece of fabric; and
forming pores in the non-perforated piece of fabric with a laser to obtain a piece of fabric comprising a plurality of micrometric pores distributed among a surface of the piece of fabric, the micrometric pores being sized, positioned and oriented to allow a passage of at least one of: heat, moisture, vapors and water therethrough.

51-53. (canceled)
